(19) United States
(12) Patent Application Publication
(10) Pub. No.: US 2004/0166043 A1
(43) Pub. Date: Aug. 26, 2004

(54) Gas scrubbing reagent and methods for using same

(76) Inventors: Robert W. Vandine, Montoursville, PA (US); Anthony S. Campo, Huntington, NY (US); Dwight R. Foster, Randolph, NJ (US)

Correspondence Address: NIXON & VANDERHYE, PC, 1100 N GLEBE ROAD, 8TH FLOOR, ARLINGTON, VA, 22201-4714, US

(21) Appl. No.: 10/784,742

(22) Filed: Feb. 24, 2004

Related U.S. Application Data
(60) Provisional application No. 60/448,907, filed on Feb. 24, 2003.

(51) Int. Cl. B01J 20/10

(52) U.S. Cl. 423/245.1; 502/401

(57) ABSTRACT

A reagent composition for removing a contaminant from a gas. The reagent composition contains (1) a silicate compound; (2) a sequestrant; and optionally a surfactant. The reagent composition may be used in methods to remove contaminants from gases. The reagent composition in combination with micro/miniature mechanical structures provides for reduced back pressure and reduced volume of the reaction chamber.

### CROSS REFERENCE TO RELATED APPLICATION

This patent application is related to, and claims the benefit of, U.S. Provisional Patent Application No. 60/448,907, filed 24 Feb. 2003, the entire disclosure of which is incorporated herein by reference.

### FIELD OF THE INVENTION

The present invention relates to treatment of gas streams to remove entrained solids and gaseous air pollutants such as particulates, volatile organic compounds (VOCs), nitrogen oxides (NOₓ), sulfur oxides (SOₓ) and carbon oxides (COₓ). More particularly, the present invention relates to a reagent composition and method for using same in a wet scrubbing apparatus to scrub or remove these entrained solids and gaseous air pollutants from a flue gas stream. The present Invention also relates to a reagent composition of sufficiently low viscosity and surface wetting capacity that can be used in combination with a coupling agent to form a film on micro/miniature structures or particulate materials that have a high surface area. The micro/miniature structures in combination with the reagent composition enables the scrubbing of air pollutants in a low volume reaction chamber or in low back pressure applications, such as in combustion engine exhausts. The present invention is useful for, without limitation, removing hazardous substances and air pollutants in gas streams from carbonaceous burning fuels, other combustion sources, and from air streams entering into or circulating within buildings as make-up air.

### BACKGROUND OF THE INVENTION

The air quality in large metropolitan regions has become increasingly unhealthy due to the high levels of polluting gases from utilities, automobiles and other mobile and stationary sources. Many sources contribute to overall air pollution, for example, fossil fuel combustion in stationary systems (e.g. diesel powered generators, electric power plants; cement, ceramic, chemical and other manufacturing plants) and mobile systems (e.g. diesel trucks, buses, automobiles, air planes), gasoline marketing operations, industrial coatings, and solvent usage. The presence of air pollutants or contaminants such as particulates, volatile organic compounds (VOCs), nitrogen oxides (NOₓ), sulfur oxides (SOₓ) and carbon oxides (COₓ) in combustion gases is a source of air pollution and acid rain. Acidic gases are typically found in flue gas streams whenever sulfur-containing fuels are burned whereby sulfur is converted to sulfur dioxide and sulfur trioxide (together known as “SOₓ”) and released into the atmosphere along with other flue gases and entrained particulate and hazardous substance materials. Combustion of carbonaceous fuels also results in the formation of nitric oxide and nitrogen dioxide (together known as “NOₓ”), which also exit the stack with the combustion exhaust materials. However, as in the case of particulates, the emissions of both NOₓ and SOₓ are subject to certain output standards because of acid rain legislation and mandatory ambient air quality criteria. Therefore, at least with respect to SOₓ, a solution has been to burn low-sulfur fuels to ensure compliance with SOX emission requirements. Large consumers of fuel, and especially fossil fuels such as coal, have been forced to use a low sulfur fuel and to sufficiently remove the sulfur dioxide from the combustion gases in order to comply with government-imposed emissions standards. Unfortunately, this adversely affects the use of older emission control devices that were originally designed to work in units burning higher-sulfur fuels. There are also enormous costs associated with transporting low-sulfur fuels to locations where such fuels are not found in abundance. Nevertheless, this has not achieved the necessary reductions and further improvements will be mandated to lower polluting emissions and improver regional air quality standards. As a result, reducing the amount of air pollutants is an economic and health challenge.

Combustion of carbonaceous materials containing significant amounts of sulfur, including fossil fuels and waste, is being closely regulated by governments around the world. Free radicals of sulfur and oxygen are released and combine at the elevated temperatures involved to produce a variety of oxides of sulfur. Environmental regulations require that emissions of certain materials in flue gases be kept at levels not exceeding those set forth in federal, state, and local specifications. To comply with these legal mandates, particulate emissions must satisfy certain standards in terms of pounds per million Btu input, pounds per unit time, and opacity of stack effluent. The term “particulate” within the meaning of these restrictions generally refers to fly ash and other fine particles found in flue gas streams and can include a host of hazardous substances, such as those listed in 40 CFR .§302.4 (e.g., arsenic, ammonia, ammonium sulfite, mercury, and the like).

Numerous strategies have been being employed to reduce the discharge of SOₓ to the atmosphere. Among these are methods for cleaning sulfur from fuels prior to combustion, methods for chemically tying up the sulfur during combustion, and methods for removing the sulfur oxides from combustion effluents. Among the methods for treating combustion effluents to remove SOₓ, are wet and dry scrubbing.

Wet scrubbing technology is well developed and effective; however, very large equipment has been required and costs are proportional. Examples are described in U.S. Pat. Nos. 6,231,648; 6,093,250; 5,951,743; 5,620,144; 5,250,267; 5,178,654; 5,147,421; 4,923,688; 4,164,547; 4,067,707; and 4,012,469. The technology for wet scrubbing combustion effluents to remove SOₓ provides gas-liquid contact in a number of different configurations. Among the most prominent are the single- and double-loop countercurrent spray towers and towers which employ both concurrent and countercurrent sections. The single-loop, open-tower systems employing calcium carbonate to react with the SOₓ are the simplest in construction and operation. These systems are often preferred because they can be operated with low pressure drop and have a low tendency to scale or plug. The advantages of their simplicity and reliability have, however, been offset in some situations by their large size. For example, because they do not employ any trays or packings to improve contact between the effluent and the scrubbing liquid, tower heights are typically high and many levels of spray nozzles have been employed to assure good gas-liquid contact. Pumping is a major cost, which increases with the head of fluid that must be pumped. Taller towers, thus, increase the cost of construction and operation. So called open spray towers (i.e., those not having packings, trays or other means for facilitating gas-liquid contact) are simple in design and provide high reliability. They are especially useful in coal-fired power stations where the evolution of chlorides has caused a number of problems, including reduced reactivity of the scrubbing solution and severe corrosion of scrubber internals. Another factor favoring the use of open spray towers is their inherent low pressure loss and resulting fan power economy.

Flue gas conditioning methods are generally performed by adding a chemical into the flue gas streams of boilers, turbines, incinerators, and furnaces to improve the performance of downstream emission control devices. Although the term is usually associated with the removal of particulates caused by coal combustion, flue gas conditioning can be equally effective in controlling particulates caused by the burning of any carbonaceous fuel. For instance, in single-loop, countercurrent, open scrubbing towers, a scrubbing slurry composed of calcium carbonate, calcium sulfate, calcium sulfite, and other non-reacting solids flows downwardly while the SOₓ-laden effluent gas flows upwardly. The SOₓ, principally SO₂, is absorbed in the descending scrubbing slurry and is collected in a reaction tank where calcium sulfite and calcium sulfate are formed. Desirably, the reaction tank is oxygenated to force the production of sulfate over sulfite. Once the crystals of sulfate are grown to a sufficient size, they are removed from the reaction tank and separated from the slurry.

The performance of downstream emission control devices, such as electrostatic precipitators, often depends upon the chemistry of the flue gases and, in particular, such factors as the fuel sulfur content, particulate composition, particulate resistivity, and the cohesion properties of entrained particulates, to name a few. Chemical additives either to the fuel prior to combustion or to the flue gas stream prior to the electrostatic precipitator can correct the deficiencies of the precipitator to meet particulate emissions standards (e.g., mass emission and visual opacity). One of the objects of flue gas conditioning is to enhance the effectiveness of the electrostatic precipitation process by manipulating the chemical properties of the materials found in the flue gas stream.

Gases, such as ammonia and sulfur trioxide, when injected into the flue gas stream prior to a cold-side electrostatic precipitator, have been known to condition the fly ash for better precipitator performance. Similar results have been obtained with inorganic chemical compounds, such as ammonium sulfate, sodium bisulfate, sodium phosphate, or ammonium phosphate. The use of sulfuric acid has also been proposed, as well as mixtures of these inorganic compounds in the form of undisclosed “proprietary blends.” These compounds have been added either as a powder or as an aqueous solution to the flue gas stream.

Organic compounds, such as ethanol amine and ethanol amine phosphate, have also been used as flue gas conditioning agents. Free-base amino alcohols, such as morpholine (including morpholine derivatives), have been used as well to augment the flow characteristics of treated fly ash. Similarly, the use of alkylamine (such as tri-n-propylamine) and an acid containing sulfur trioxide (such as sulfamic acid) has been proposed to lower the resistivity of fly ash.

Anionic polymers have been employed in situations where the fly ash resistivity needs to be lowered, particularly when a low-sulfur coal is utilized. Similarly, cationic polymers have been suggested whenever the electrical resistivity needs to be raised from a low value, such as when using high-sulfur coal. Anionic polymers containing ammonium and sodium nitrate have also been known to increase the porosity of fly ash for principal application in bag houses.

The use of inorganic salts, such as sodium sulfate, sodium carbonate, or sodium bicarbonate added directly to the coal before combustion has been known to correct the “sodium depletion” problems of a hot-side precipitator. Sodium carbonate and sodium bicarbonate have also been injected directly into the flue gas stream prior to the hot-side precipitator, but this mode of application has not been commercialized.

The principal post-combustion method for controlling Sₓ emissions involves the saturation of basic chemicals with the flue gases through the use of a “scrubber.” In this removal method, advantage is taken from the fact that SOₓ is acidic in nature and will react with basic additives to form an innocuous sulfate. Essentially, the principle underlying the various forms of scrubber technologies is to utilize simple acid-base reactions to control SOₓ emissions. However, conventional scrubber designs are very capital intensive to build and remain expensive to operate in terms of labor, energy, and raw material costs.

There are many types of scrubbers currently in use. In wet scrubbers (which are normally located after an emission control device), flue gas is brought into direct contact with a scrubbing fluid that is typically composed of water and a basic chemical such as limestone (calcium carbonate), lime, caustic soda, soda ash, and magnesium hydroxide/carbonate, or mixtures of these. Water-soluble nitrite salts have also been added to the scrubbing medium for the purpose of enhancing the SOₓ-removal efficiency of wet scrubbers. The use of organo phosphonic acid in conjunction with water-based solutions or slurries that react with sulfur dioxide have been known to improve the utilization of the basic material in a wet scrubber. Similarly, polyethylene oxide compounds have been added to the flue gas as a sludge de-watering agent for improving the wet scrubber's efficiency.

In dry scrubbers, slurries of lime or mixtures containing lime and other basic chemicals are injected into the flue gas stream as sprays. Unlike the wet scrubbers, the injection of these chemicals in dry scrubbers is usually conducted before the emission control device. After injection, the unreacted chemicals and reaction products become entrained with the flue gas stream and are separated from the flue gas along with other particulates in the downstream emission control device using common particulate removal techniques. However, a problem encountered with this method of SOₓ removal is that the unreacted chemicals and reaction products cause a very heavy particulate load on the downstream emission control device. This method of removal is also less efficient than wet scrubbing techniques due to the low reaction rates between sulfur dioxide and the dry scrubbing additives.

Because of its very high reaction rate with sulfur dioxide, a compound known as “trona” (a hydrous acid sodium carbonate) has also been injected into the flue gas stream in dry scrubbers (upstream from the emission control device) in an effort to reduce SOₓ emissions. Unfortunately, trona produces an undesirable side effect--it provokes NO₂ formation, which is another pollutant that is very visible in the plume by its characteristic brown, aesthetically unacceptable color. Notwithstanding its low cost, therefore, trona has not acquired much popularity.

The use of soda ash (anhydrous sodium carbonate), caustic soda (sodium hydroxide), and calcium hydroxide in dry and wet scrubbers has also proven effective in reducing SOₓ emissions. However, these strong bases have achieved limited commercial success because of high raw material costs. For example, 1.25 tons of caustic soda is required for removing every ton of sulfur dioxide produced. For a 500-megawatt power station burning 2% sulfur coal, it would require 270 tons of soda per day to keep SOₓ emissions within acceptable levels.

As mentioned previously, NOₓ is also produced during the combustion of carbonaceous fuels. NOₓ is generated by several means, such as the fixation of nitrogen present in combustion gases, the conversion of fuel-derived nitrogen, and prompt NOₓ formation. Prompt NOₓ formation is a small contributor and only occurs under very fuel-rich operations.

There are several methods by which NOₓ emissions have been controlled. One of these methods include the injection of ammonia directly into the combustion chamber. Maintaining a close temperature control between 1650° F. to 1832° F. is essential under this technique; otherwise, the desired NOₓ removal will not occur, and there will be an excessive emission of unreacted ammonia. Excessive emissions of unreacted ammonia from the combustion chamber (known as “ammonia slippage”) not only adds to pollution but also plugs or jams downstream equipment. Ammonia slippage thus becomes a problem in its own right.

In another method for NOₓ removal, known as “SCR” or selective catalytic reduction, ammonia is added to the flue gas stream at temperatures above 800° F. The mixed stream is then passed over a catalyst where the NOₓ removal process is effected. Despite being the most expensive technology, based both on initial capital and operating costs, this method has provided the best removal rates of NOₓ (removal rates of 90% to 99% are common). Unfortunately, however, the catalysts are subject to degradation over time, as well as poisoning by sulfur-containing gases and poisoning and blinding by fly ash.

In yet another method, known as “SNCR” or selective non-catalytic reduction, urea (or its precursors) is injected into the flue gas stream at temperatures between 1600° F. to 1800° F. As in the case of the ammonia-injection method for NOₓ control, however, the SNCR process must operate in a narrow temperature window or else ammonia slippage will occur or too little NOₓ reduction will be achieved. Although combinations of SNCR and SCR have been proposed, they have presented similar limitations.

In combustion gas treatment systems that include a fabric filter, one approach is to mix activated carbon with a filter pre-coat medium (for example slaked lime or sodium bicarbonate), which acts as an adsorbent for micro-pollutants present either in the gas phase (VOC, volatile organic carbon compounds) or as finely dispersed particulate matter. This approach removes the micro-pollutants from combustion gases, including PCDD (poly-chlorinated dibenzodioxine) and PCDF (poly-chlorinated dibenzofuran) micro-pollutants, and transfers them to the filter dust. Disadvantages of this approach are the costs both of the activated carbon itself and also of the disposal of the dust contaminated with the micro-pollutants.

Another method of eliminating the micro-pollutants is to install a catalytic final treatment unit downstream of the rest of a combustion gas scrubbing system. Such final treatment units are of two different types; the first type is catalytic oxidation in which the micro-pollutants, including the PCDD/PCDF micro-pollutants, are decomposed into carbon dioxide (CO₂), water vapor (H₂O) and halogen acid gases (HCI etc.) under the combined action of the oxygen (O₂) present in the gases and a suitable metallic solid-phase catalyst, typically containing vanadium as the active metal. The major disadvantage of this type of catalyst is that, in addition to oxidizing the micro-pollutants, the catalyst also oxidises the colorless nitric oxide (NO) present in the combustion gases into the intensely orange-colored nitrogen dioxide (NO₂). This presents an aesthetic problem whose elimination requires the (catalytic) reduction of the nitric oxide to nitrogen (N₂). This may be effected by means of the same catalyst but requires also the injection of ammonia or some other source of reduced nitrogen such as urea. The second type of catalytic final treatment unit is based on the use of a ceramic catalyst which decomposes the micro-pollutants, including the PCDD/PCDF micro-pollutants, into carbon monoxide (CO), water vapor (H₂O) and halogen acid gases (HCI etc.) through a mechanism based mainly on cracking which does not appreciably oxidize the nitric oxide (NO). While such processes may cost less in investment and operating costs than the oxidative processes, they nevertheless still represent a significant additional cost to the overall combustion gas treatment system. Such catalytic processes operate in a temperature range above those of the operation of wet scrubbing systems and in some examples also above those of fabric filters, making it necessary to include a heat exchanger and auxiliary burner in the process scheme with a consequent increase in investment and operating costs. In other examples, the catalytic processes are very sensitive to the presence of dust in the gas to be treated, rendering obligatory the installation of a filter upstream.

The above methods may employ materials that are caustic and corrosive to operators and equipment. These materials have many disadvantages in terms of the costs to scrub the pollutants from a flue gas stream. Additionally, the employed materials are effective on only one specific pollutant. An example is the lime slurry wet scrubbers. In such methods an alkaline slurry is employed. This method may be effective on SO₃ but is ineffective on other pollutants. Additionally, the use of lime slurries is corrosive to metal structures. This attribute increases the operating and maintenance costs. Lime slurries also require large capital equipment and high energy costs to prepare and employ the slurries in wet scrubbers. In other cases a catalyst is used to react with the target pollutants. These catalysts are effective for species such as NO₂ but are not effective on SO₃ or CO₂. It would be advantageous if one reagent could be used to remove most, if not all, if the above-described air pollutants from a gas stream in a single process cycle without the release of any VOCs into the environment.

Accordingly, there remains a need for reagents and methods that do not exhibit the above-described disadvantages. Unlike the aforementioned emission control methods, use of the reagent compositions of the present invention provides an effective, efficient, and low-cost means for controlling particulate, hazardous substance, NOₓ, and SOₓ emissions without exhibiting any of the above limitations. Moreover, use of the inventive compositions fills an important need by reducing these emissions simultaneously. Because of these desirable characteristics, the present invention constitutes a significant advancement over prior gas scrubbing technology.

### BRIEF DESCRIPTION OF THE DRAWINGS

The accompanying drawings, which are incorporated in, and constitute a part of the specification, illustrate embodiments of the present invention and, together with the description, serve to explain the principles of the present invention.

FIG. 1 shows SO₂ gas concentration (ppm) evolution exiting reactor filled with 0, 10, 50 weight % of the reagent composition of the present invention.

FIG. 2 shows SO₂ gas concentration (ppm) and pH evolution exiting reactor filled with 10 weight % of the reagent composition of the present invention.

FIG. 3 shows SO₂ gas concentration (ppm) and pH evolution exiting reactor filled with 50 weight % of the reagent composition of the present invention.

### SUMMARY OF THE INVENTION

It is an object of the invention to provide an aqueous, inorganic-based sequestering, scavenging and scrubbing chemical dissolution/cleaning reagent composition and method that is non-toxic, non-flammable and non-corrosive to metals and dielectrics and methods of using said reagent composition to remove one or more contaminants from a gas.

It is another object to provide a reagent composition that is capable of removing VOCs, SOₓ, NOₓ, COₓ, particulates, inorganic hazardous air pollutants (IHAPs) and other hazardous substances in a gas stream.

It is also an object of the invention to provide a process for removing contaminants from flue gases of high-temperature processes, for example in coal-fired power stations, sewage sludge incineration, domestic waste or special waste incineration facilities, and the like.

It is still another object to provide a chemical dissolution system that does not corrode metal surfaces, is non-toxic to animals, humans and other life forms (fish, etc.), and is not harmful to the environment.

It is yet another object of the present invention to provide a reagent composition and method for using same for deodorizing a gas stream and/or eliminating organic based odors and/or mercaptens from a gas.

One or more of the above and other objects are achieved by the present invention, which provides a reagent composition comprising: (1) a silicate compound; (2) an organic or inorganic sequestrant or mixtures of sequestrants; and optionally (3) a surfactant. The reagent composition may be used as sequestering, scavenging, scrubbing, or chemical dissolution reagent to remove contaminants from a gas stream.

The present invention further encompasses a method comprising a step of contacting a gas with the reagent composition of the present invention, which acts as a scrubbing medium to absorb contaminants from the flue gas. The method may be employed in a conventional gas scrubbing apparatus for scrubbing acid-base interactions with water and themselves producing a relatively high pH (>12) basic solution. In this aspect, the reagent composition of the present invention is mixed with a waste gas stream in an existing separator drum typically associated with wet gas scrubbers. A conventional separator drum may contain hardware such as spray nozzles located within the separator drum.

In one aspect, a contaminated waste gas stream is directed to a separator drum and the reagent composition is sprayed through spray nozzles so that the stream contacts the reagent composition. The reagent composition can be first mixed with water, preferably deionized water, which acts as a carrier fluid to better disperse it into the separator drum.

In another aspect, a waste gas stream is passed through an initial contaminant removal step to remove at least a fraction of contaminants initially present in the waste gas stream in order to reduce the amount of reagent composition needed. In this first contaminant removal step, at least about 10 vol. %, preferably from about 10 vol. % to about 30 vol. %, more preferably from about 20 vol. % to about 60 vol. %, and most preferably about 30 vol. % to about 90 vol. %, of the contaminants initially present in the waste gas stream are removed before the waste gas stream is mixed with the reagent composition. The type of, or manner in which, an initial amount of contaminant species is removed before the waste gas stream is mixed with the reagent composition is not critical and may be a mere design choice.

Accordingly, the present invention entails a method for separating a contaminant from an air or gas stream contaminated with one or more contaminants therewith, comprising the steps of (a) passing said contaminated air into a contact zone in which is disposed the reagent composition of the present invention; and (b) withdrawing from said zone, air depleted of said contaminant or contaminants. To effect contact, the reagent composition of the present invention may be sprayed into the contaminated gas stream or impregnated into a woven or non-woven cloth or fabric that is placed in such a manner to effectuate contact with the contaminated gas or air stream. Thus, the present invention scrubs (or treats) a gas or air stream for the purpose of returning it to its ambient or non-contaminated composition.

Without wishing to be bound by any theory of operation or model, it is believed that when the reagent composition of the present invention is used to scrub a contaminated gas stream, the pH of the reagent composition decreases as the to-be-dissolved target chemical species are dissolved, sequestered, scavenged or scrubbed from a gas. Others multi-components provides sequestering (binding; segregate) on the molecular level as well as control of the volatility (life-time) of the chemical dissolution system and control of the viscosity, flow and surface activity of the chemical dissolution system.

It will be understood that the features of the present invention will be described to have preferred application to flue gases emitted from the burning of carbonaceous fuels (e.g., in a boiler), and this embodiment will be described for purposes of illustrating the invention and its advantages. The invention is not limited to this embodiment and effluents from all types of combustion sources and utilizing packed or other types of scrubbing apparatus are envisioned. For example, the present invention is also applicable to cleaning or scrubbing indoor air circulated through closed HVAC systems.

Additional objects and attendant advantages of the present invention will be set forth, in part, in the description that follows, or may be learned from practicing or using the present invention. The objects and advantages may be realized and attained by means of reagent compositions and methods pointed out in the appended claims. It is to be understood that the foregoing general description and the following detailed description are exemplary and explanatory only and are not to be viewed as being restrictive of the invention, as claimed.

### DESCRIPTION OF PREFERRED EMBODIMENTS

All patents, patent applications and literatures cited in this description are incorporated herein by reference in their entirety. In the case of inconsistencies, the present disclosure, including definitions, will prevail.

Before proceeding with a description of the specific embodiments of the present invention, a number of terms will be defined. As used herein, “contaminant” means a material not naturally occurring in ambient air and/or a material naturally occurring in air but present at a concentration above that found in ambient air. Often, these contaminants are termed “pollutants”, i.e., a harmful chemical or waste material discharged into the water or atmosphere; something that pollutes (Webster's New World Dictionary of the American Language, 2nd College Edition, D. B. Guralinik, editor-in-chief, William Collins & World Publishing Co., Inc., 1974). Often, the term “acid gas” or “acid rain” or “acid deposition” is used to apply to these contaminants, a complex chemical and atmospheric phenomenon that occurs when emissions of sulfur and nitrogen compounds are transformed by chemical processes in the atmosphere, often far from the original sources, and then deposited on earth in either wet or dry form. The wet forms, popularly called “acid rain”, can fall as rain, snow, or fog. The dry forms are acidic gases or particulates. Thus, gaseous and vaporous wastes, such as COₓ, SOₓ, NOₓ, H₂S, IHAPs and VOC's, such as benzene, formaldehyde, acetone, toluene, methylene chloride, mercury and the like are “contaminants” advantageously treated in accordance with the precepts of the present invention. However, it must be recognized that “contaminants” may be beneficial gases or vapors not naturally occurring in ambient air and which can be scrubbed or sorbed for their separation of an air stream by the invention disclosed herein. The terms flue gas, wet gas, combustion effluent stream, combustion waste gas effluent stream, waste gas, offgas, and waste gas stream are used interchangeably herein and in the art. Also, the terms wet gas scrubber, scrubbing apparatus, and scrubber are also sometimes used interchangeably herein and in the art.

In a preferred embodiment, the reagent of the present invention comprises: (1) a silicate compound; (2) an organic or inorganic sequestrant or mixtures of sequestrants; and optionally (3) a surfactant. In addition to the above components, the above reagent may also contain (1) butyl diglycol [CAS 112-34-5] (also known as Diethylene glycol monobutyl ether; 2-(2-butoxyethoxy)ethanol), (2) dipropylene glycol [CAS 25265-71-8] (also known as 1,1′-oxydi-2-propanol; 2,2′-dihydroxydipropyl ether or oxybispropanol), and (3) EDTA [CAS 60-00-4] ((ethylenedinitrilo) tetraacetic acid) (also known as edetic acid; versene acid; ethylenediaminetetraacetic acid), it being understood that dipropylene glycol is most preferred.

In another preferred embodiment, the aqueous reagent composition may be used in combination with micro/miniature mechanical structures for cleaning an air stream of multiple pollutants or contaminants, and in conditions having significantly reduced back pressure. In this embodiment, the micro/miniature mechanical structures may be recharged by the aqueous reagent composition so that it is cleaned for reuse.

Silicate compounds useful in accordance with the present invention include, without limitation, alkaline metal ortho, meta-, di-, tri-, and tetra-silicates such as sodium orthosilicate, sodium sesquisilicate, sodium sesquisilicate pentahydrate, sodium metasilicate (anhydrous), sodium metasilicate pentahydrate, sodium metasilicate hexahydrate, sodium metasilicate octahydrate, sodium metasilicate nanohydrate, sodium disilicate, sodium trisilicate, sodium tetrasilicate, potassium metasilicate, potassium metasilicate hemihydrate, potassium silicate monohydrate, potassium disilicate, potassium disilicate monohydrate, potassium tetrasilicate, potassium, tetrasilicate monohydrate, or mixtures thereof. It will be appreciated that alkali metal silicates of sodium and/or potassium are preferred and readily available commercially, sodium silicates being available from DuPont as Silicate F, having an SiO₂ to Na₂O ratio of about 3.25:1 and from PO Corporation as Silicate N having an SiO₂ to Na₂O ratio of about 3.25:1 and potassium silicate available from PQ Corporation as Kasil® having an SiO₂ to K₂O ratio of about 2.5 to 1, for example. Sodium metasilicate [CAS 6834-92-0] having an SiO₂ to Na₂O ratio of about 1:1 is most preferred and is available from several suppliers. Sodium metasilicate is also known in the art as silicic acid (H₂SiO₃) disodium salt; crystamet; disodium metasilicate; disodium monosilicate; orthosil; drymet; sodium metasilicate, anhydrous; sodium silicate; water glass, etc.

Suitable organic or inorganic sequestrant or mixtures of sequestrants useful in accodance with the present invention include, without limitation sodium gluconate salts, sodium citrate salts, sodium p-ethylbenzenesulfonate salts, sodium xylenesulfonate salts, citric acid, the alkali metal salts of nitrilotriacetic acid (NTA), EDTA, alkali metal gluconates, polyelectrolytes such as a polyacrylic acid, and the like. More preferred sequestrants include organic sequestrants such as a gluconic acid material, e.g., sodium gluconate [CAS 527-07-1] also known as gluconic acid, sodium salt; gluconic acid, monosodium salt; gluconic acid sodium salt. Gluconic acid material” is intended to include and refer to gluconic acid itself, and to other water soluble and/or water dispersible forms of gluconic acid, such as the alkali metal gluconates and glucoheptonates, in particular to sodium gluconate and gluconodelta-lactone.

The reagent composition of the present invention can be optionally formulated to contain effective amounts of a surfactant and/or a wetting agent, as needed. Suitable surfactants or surface active or wetting agents, including anionic, nonionic or cationic types which are soluble and effective in alkaline solutions. The surfactants must be selected so as to be stable and compatible with other components. The total level of surfactant is preferably from about 0.1% to about 50%, more preferably from about 0.1% to about 40%, still more preferably about 2% to about 30%; and especially from about 3% to about 15% by weight. The compositions may comprise a mixture of anionic with zwitterionic and/or amphoteric surfactants. Other suitable compositions within the scope of the invention comprise mixtures of anionic, zwitterionic and/or amphoteric surfactants with one or more nonionic surfactants including, without limitation, soluble or dispersible nonionic surfactants selected from ethoxylated animal and vegetable oils and fats and mixtures thereof.

In another aspect, the present invention may optionally comprise a surfactant in an amount where it acts as an emulsifying, a wetting, and/or a dispersing agent. Examples of suitable surfactants include, but are not limited to, anionic surfactants such as carboxylates, for example, a metal carboxylate of a long chain fatty acid; N-acylsarcosinates; mono or di-esters of phosphoric acid with fatty alcohol ethoxylates or salts of such esters; fatty alcohol sulphates such as sodium dodecyl sulphate, sodium octadecyl sulphate or sodium cetyl sulphate; ethoxylated fatty alcohol sulphates; ethoxylated alkylphenol sulphates; lignin sulphonates; petroleum sulphonates; alkyl aryl sulphonates such as alkyl-benzene sulphonates or lower alkylnaphthalene sulphonates, e.g., butyl-naphthalene sulphonate; salts or sulphonated naphthalene-formaldehyde condensates; salts of sulphonated phenol-formaldehyde condensates; or more complex sulphonates such as amide sulphonates, e.g., the sulphonated condensation product of oleic acid and N-methyl taurine or the dialkyl sulphosuccinates, e.g., the sodium sulphonate or dioctyl succinate. Further non-limiting examples of suitable surfactants are nonionic surfactants such as condensation products of fatty acid esters, fatty alcohols, fatty acid amides or fatty-alkyl- or alkenyl-substituted phenols with ethylene oxide, block copolymers of ethylene oxide and propylene oxide, acetylenic glycols such as 2,4,7,9-tetraethyl-5 decyn4,7-diol, or ethoxylated acetylenic glycols. Additional non-limiting examples of suitable surfactants are cationic surfactants such as aliphatic mono-, di-, or polyamines such as acelates, naphthenates or oleates; oxygen-containing amines such as an amine oxide of polyoxyethylene alkylamine; amide-linked amines prepared by the condensation of a carboxylic acid with a di- or polyamine; or quaternary ammonium salts. When utilized, the surfactant is present in a preferred amount of between about 0.05% w/w and about 25% w/w, more preferably between about 1% w/w and about 8% w/w.

Amphoteric surfactants, surfactants containing both an acidic and a basic hydrophilic group are preferred for use in the present invention. Amphoteric surfactants can contain the anionic or cationic group common in anionic or cationic surfactants and additionally can contain ether hydroxyl or other hydrophilic groups that enhance surfactant properties. Such amphoteric surfactants include betain surfactants, sulfobetain surfactants, amphoteric imidazolinium derivatives and others. One class of preferred surfactants are the water-soluble salts, particularly the alkali metal (sodium, potassium, etc.) salts, or organic sulfuric reaction products having in the molecular structure an alkyl radical containing from about eight to about 22 carbon atoms and a radical selected from the group consisting of sulfonic acid and sulfuric acid ester radicals.

Preferred anionic organic surfactants include alkali metal (sodium, potassium, lithium) alkyl benzene sulfonates, alkali metal alkyl sulfates, and mixtures thereof, wherein the alkyl group is of straight or branched chain configuration and contains about nine to about 18 carbon atoms. Examples include sodium decyl benzene sulfonate, sodium dodecylbenzenesulfonate, sodium tridecylbenzenesulfonate, sodium tetradecylbenzene-sulfonate, sodium hexadecylbenzenesulfonate, sodium octadecyl sulfate, sodium hexadecyl sulfate and sodium tetradecyl sulfate.

Nonionic synthetic surfactants may also be employed, either alone or in combination with anionic types. This class may be broadly defined as compounds produced by the condensation of alkylene oxide groups (hydrophilic in nature) with an organic hydrophobic compound, which may be aliphatic or alkyl aromatic in nature. The length of the hydrophilic or polyoxyalkylene radical which is condensed with any particular hydrophobic group can be readily adjusted to yield a water soluble or dispersible compound having the desired degree of balance between hydrophilic and hydrophobic elements.

Other suitable oil-derived nonionic surfactants include ethoxylated derivatives of almond oil, peanut oil, rice bran oil, wheat germ oil, linseed oil, jojoba oil, oil of apricot pits, walnuts, palm nuts, pistachio nuts, sesame seeds, rapeseed, cade oil, corn oil, peach pit oil, poppyseed oil, pine oil, castor oil, soybean oil, avocado oil, safflower oil, coconut oil, hazelnut oil, olive oil, grapeseed oil, and sunflower seed oil.

In addition to the above components, the above reagent composition of the present invention may also contain one or more of the following: (1) butyl diglycol, (2) dipropylene glycol, and (3) EDTA.

In a preferred embodiment, the reagent composition of the present invention and a method of making same comprises:

about 1 to about 15 weight % of a silicate compound (e.g., sodium metasilicate) dissolved in 60 gallons of water that has been pre-heated to and maintained at about 90° C. (the temperature of the mixture is maintained at about 90° C. and aggressively stirred with an inversion mechanical mixer);

about 1 to about 15 weight % of organic or inorganic sequestrant or mixtures of sequestrants (e.g., sodium gluconate) which added to the above mixture;

about 1 to about 15 weight % of dipropylene glycol or butyl diglycol which is added to the above mixture; and

about 10 to about 20 weight % of a surfactant is added to the above mixture already containing sodium metasilicate, sodium gluconate and dipropylene glycol after the temperature of the above mixture has been lowered to about 50° C.

The present invention will be further illustrated in the following, non-limiting Examples. The Examples are illustrative only and do not limit the claimed invention regarding the materials, conditions, process parameters and the like recited herein.

### EXAMPLE 1

This example demonstrates an exemplary reagent composition (pH of 12.6) of the present invention.

about 86.5 weight % of water at about 90° C.;

about 1.5 weight % of sodium metasilicate at about 90° C.;

about 2 weight % of sodium gluconate at about 90° C.;

about 5 weight % of butyl-diglycol (CAS 112-34-5) at about 50° C.; and

about 5 weight % of surfactant at about 50° C.

The above components are mixed, one after the other, in the above order.

### EXAMPLE 2

This example demonstrates an exemplary reagent composition (pH of 12.9) of the present invention.

about 73 weight % of water at about 90° C.;

about 5 weight % of EDTA at about 90° C.;

about 5 weight % of sodium metasilicate at about 90° C.;

about 5 weight % of butyl-diglycol (CAS 112-34-5) or dipropylene glycol (CAS 25265-71-8) at about 50° C.; and

about 12 weight % of surfactant at about 50° C.

The above components are mixed, one after the other, in the above order.

### EXAMPLE 3

This example demonstrates the effects of a reagent composition comprising sodium metasilicate, sodium gluconate, butyl diglycol and a surfactant for removing SO₂ from a simulated gas stream of flue gas containing SO₂ (approximately 2,000 ppm) bubbled through tap water containing the reagent composition. Two samples of the reagent composition (HD 10% and HD 50% solutions) were tested with the HD 50% solution being tested twice, i.e., in two runs. The flue gas was produced using a series of Brooks Instruments' mass flow controllers. The gas was passed through a system of inert tubing, a chiller, and directly into a bank of continuous emissions monitoring (CEM) analyzers. The CEM bank was integrated into a data acquisition system to continuously record the gas composition before, during, and after exposure of the gas stream to the test solutions. The gas stream was then fed to a reaction vessel containing 350 mL of the solution being tested. In order to maximize the solution/gas surface area interface, an inert two-micron sintered filter was placed on the end of the gas stream delivery tube. This filter produced fine bubbles. The vessel was located in a heated beaker of water to help maintain fluid temperatures between 135° F. and 140° F. Solution pH and temperature were monitored during each test. Successful shakedown tests were performed using tap and Type II distilled water.

Solution temperatures were allowed to reach approximately 160° F. and maintained between 148° F. and 155° F. before introducing the room temperature SO₂ gas to compensate for the rapid heat loss during aeration of the fluid. All tests were allowed to run until the CEM data indicated that solution reactions had ceased. This was determined when the displayed gas composition returned to the baseline composition values. The gas stream was then diverted past the reaction vessel and passed directly through the chiller into the CEM analyzers. When the gas stream was diverted, the heat source for the test was removed and the solutions were left overnight in the reaction vessel. Data monitoring was continued to assure return to baseline gas concentration values. (It must be noted that during the test period there was noticeable evaporation of both the HD 10% and 50% solutions. The measured fluid loss from the solutions was approximately 70 and 200 ml, respectively.)

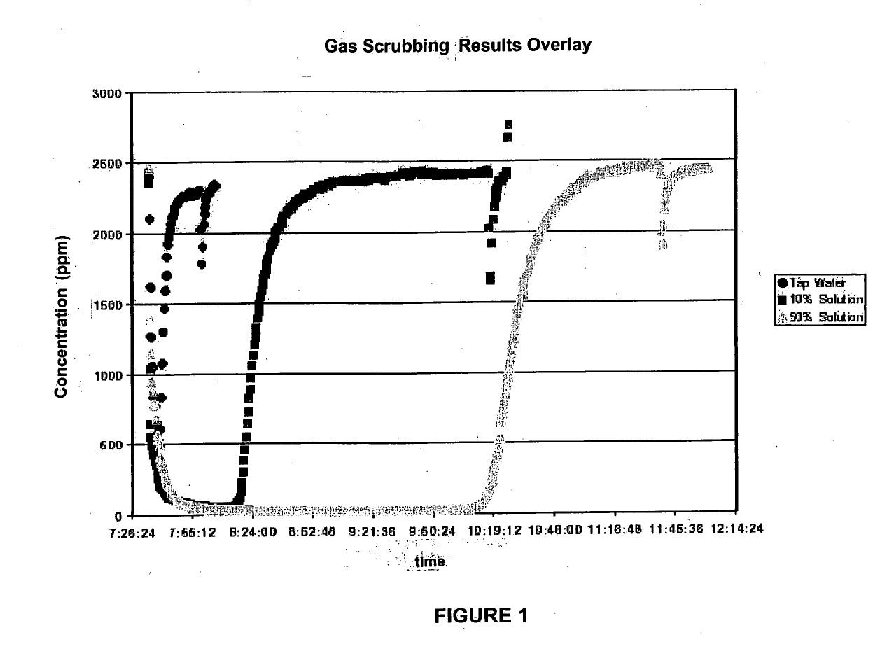

Experimental Results. Data collected during the tests performed using tap water, and the HD 10% and HD 50% solutions is presented in Tables 1 and 2 below and FIGS. 1 through 3. During each test there was a substantial reduction in SO₂ emissions due to chemical reaction of the SO₂ with the HD 10% and HD 50% solutions.

TABLE 1
Comparative SO₂ Reduction Rates

| | Time to | | | Bottom | Duration of |
|---|---|---|---|---|---|
| | achieve | Duration | | line steady | bottom line |
| | 95% | of 95% | | state | steady |
| | reduction | reduction | Maximum | reduction | state |
| Solution | (min) | (min) | reduction | (%) | (min) |
| H₂O | NA | NA | 88% | NA | NA |
| HD 10% | 10 | 33 | 98 | 97.8 | 13 |
| HD 50% | 3 | NA | 95% | NA | NA |
| (1st run) | | | | | |
| HD 50% | 13 | 153 | 99.2 | 99 | 108 |
| (2nd run) | | | | | |

TABLE 2
Time to Achieve Specified Concentrations

| | Time to Achieve Event (min) | | | |
|---|---|---|---|---|
| | Maximum | 50% | 75% | 90% |
| Solution | Reduction | Breakthrough | Breakthrough | Breakthrough |
| HD 10% | 35% | 50 | 56 | 65 |
| HD 50% | 88% | 173 | 181 | 190 |

FIG. 1 is a plot showing the SO₂ concentration measured at the reactor outlet as a function of time during the three tests. There is an almost immediate reduction in the SO₂ concentration in the gas by the HD 10% and HD 50% solutions (i.e., 97.8 and 99%, respectively). This plot also shows that the duration of maximum SO₂ reduction observed for the HD 50% solution was significantly longer than that of the HD 10% solution (i.e., 108 and 13 minutes, respectively). Tap water also demonstrated an initial and substantial drop in the SO₂ measured in the gas stream for a very short period of time (FIG. 1). In general, the HD 50% solution performed slightly better than the HD 10% concentration in maximum SO₂ reduction capability, but the HD 50% solution maintained the reduced levels of SO₂ for a significantly longer period of time than did the HD 10% solution (See Table 1).

Other observations made were the times necessary to return to 50, 75, and 95% of the breakthrough (or baseline) SO₂ values. These values were measured from the time the gas stream was introduced into the solution until the time that the event occurred. Table 2 lists the times elapsed to achieve each milestone.

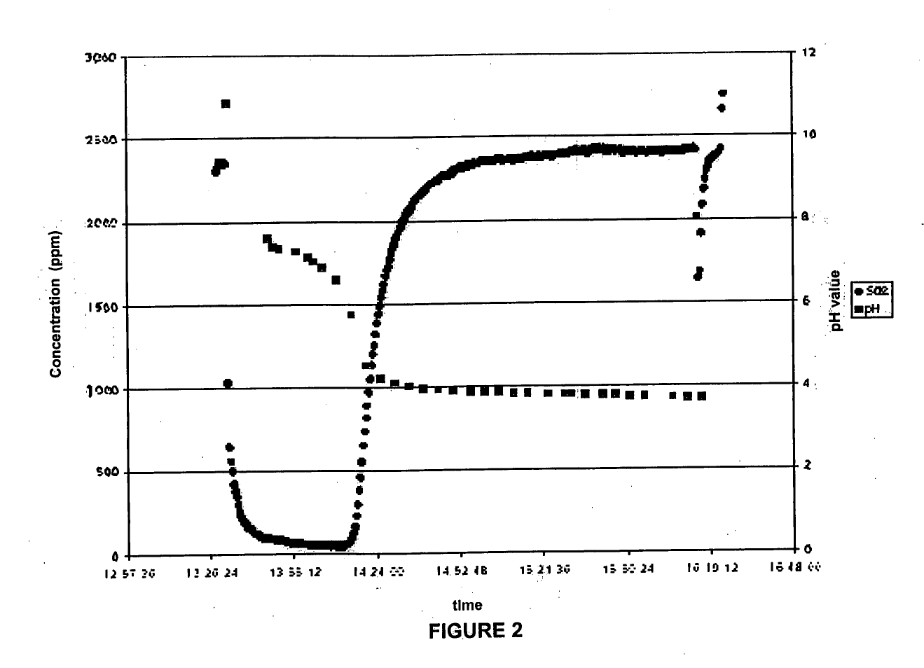

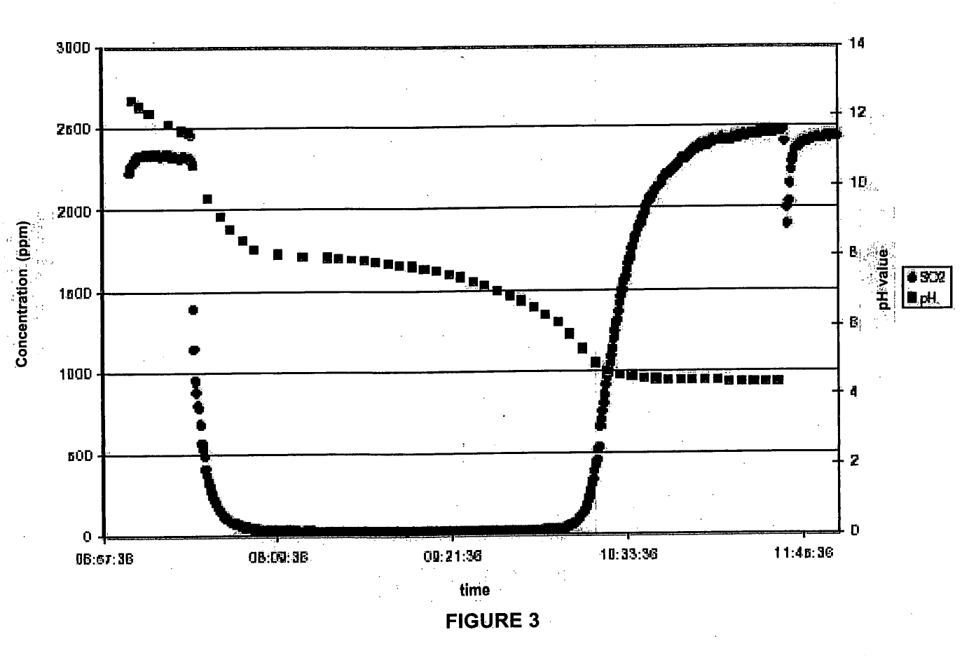

FIGS. 2 and 3 are graphs of the SO₂ concentration and pH versus time for the HD 10% and HD 50% solution tests, respectively. The initial pH of the HD 10% and HD 50% solutions was approximately 11 and 12.7, respectively. The pH of the solutions dropped rapidly upon introduction of the simulated combustion flue gas into the reactor. It was also observed that pH of the solution decreases as more SO₂ goes into solution. If the aqueous forms of sulfur are not removed, the pH will decrease until the solution becomes saturated with respect to SO₂. The result is that no SO₂ will be removed from the gas stream. In the case of tap water, the SO₂ goes into solution and remains there becoming saturated. In the case of the HD 10% and HD 50% solutions, the presumed presence of alkali earth elements (M, cations) results in the removal of the anionic sulfur species from the solution to form sulfite/sulfate precipitants.

In FIGS. 2 and 3, high SO₂ removal is observed at a pH of 7 to 8 for both solutions. Once the supply of cations is exhausted, the pH will rapidly decline and the solution will become saturated with respect to SO₂ and sulfur removal from the gas stream will stop (pH of 4 for the HD 10% solution and 4.5 for the HD 50% solution). It takes longer for the HD 50% solution to become saturated with respect to SO₂ as there is a greater quantity of cations or alkalies to remove the sulfur species from solution. It is believed that the precipitants collected from the HD 10% and HD 50% solution tests should be the same chemically. The different concentrations simply affect the length of time that the solutions were effective in removing SO₂ from the gas phase.

### EXAMPLE 5

This example demonstrates the effects of the reagent composition of the present invention of Example 3 for removing CO₂ from a gas stream. In using the reagent composition of the present invention to cleanse air for ventilation, the goal is to bubble air through the solution in such as way that air pollutants are trapped in solution leaving purified air as the output. The goals of this study were (1) to generate input air containing known concentrations of CO₂; (2) to characterize CO₂ levels in the Input Air; (3) to pass Input Air as micro-bubbles through a volume of The reagent composition of the present invention contained in a laboratory impinger; (4) to characterize the CO₂ levels in Output Air after scrubbing and (5) to calculate Capture Ratio (% CO₂ captured by the reagent composition).

Air containing 1000 ppm (nom.) CO₂ was obtained in a gas cylinder and used as Input Air. A Gas Rotameter was used to measure air flows in the range of 25-500 ml/minute. Air Measurements were made using colorimetric air monitoring tubes for CO₂ provided by Kitagawa Corp. 15 mL of the reagent composition of the present invention was placed in a glass micro-impinger consisting of a 20 mL glass bottle fitted with a glass capillary in close proximilty to and directed toward the bottom of the bottle. When the glass capillary is pressurized, Input Air passes through the capillary and “impinges” on the solution as micro-bubbles directed at the bottom of the bottle. After entering the impinger, air bubbles rise to the top of the liquid, then make their way out of the exhaust port to become Output Air. Input Air containing CO₂ was directed first into a Kitagawa measuring tube and then into a Gas Rotameter. The Flow Rate was recorded and the color displacement zone of the measurement tube was observed as a function of Time to determine the CO₂ Concentration of Input Air. The same Input Air containing CO₂ was then directed first into the Lab Impinger containing the reagent composition, then into a Kitagawa measuring tube, and then into a Rotameter. The Flow Rate was recorded and the color displacement zone of the measurement tube was observed as a function of Time to determine the CO₂ Concentration of Output Air relative to Input Air. The same Input Air containing CO₂ was directed first into a Lab Impinger containing only pure water, then to a measuring tube, and then to a Rotameter. The Flow Rate was recorded and the color displacement zone of the measurement tube was observed as a function of Time to determine the CO₂ Concentration of Output Air. The CO₂ concentration of Output Air was compared to the CO₂ concentration of Input Air to determine the Capture Ratio for CO₂. The results are shown in Table 3 below.

TABLE 3

| | | | CO₂ | |
|---|---|---|---|---|
| SAMPLE | TUBE | FLOW | (ppm found) | CAPTURE RATIO |
| Input Air | CO₂ | 100 ml/min | 1040 | |
| Output Air | CO₂ | 100 ml/min | 99 | 90% |
| Output Air | CO₂ | 100 ml/min | 89 | 91% |
| Output Air | CO₂ | 100 ml/min | 98 | 91% |

The data show that results with pure water in the impinger were no different from “Input Air” results. When Input Air containing 1000 ppm CO₂ is directed to a scrubber containing the reagent composition of the present invention, a more than 90% of the CO₂ was captured by the solution. The Capture Ratio was found to be 90-91% in these experiment, and the extent of capture is expected to be dependent upon the Flow Rate, Solution Volume, and other factors.

### EXAMPLE 6

This example demonstrates the effects of the reagent composition of the present invention Example 3 for removing NO₂ from a gas stream. In using the reagent composition of the present invention to cleanse air for ventilation, the goal is to bubble air through the solution in such as way that air pollutants are trapped in solution leaving purified air as the output. The goals of this study were to generate input air containing known concentrations of NO₂; to characterize NO₂ levels in the Input Air; to pass Input Air as micro-bubbles through a volume of the reagent composition of the present invention contained in a laboratory impinger; to characterize the NO₂ levels in Output Air after scrubbing; and to calculate Capture Ratio (%NO₂ captured by the inventive solution).

Air containing 10-20 ppm (nom.) NO₂ was obtained in a gas cylinder and used as Input Air. Lower levels for testing were obtained by dilution with air. A Gas Rotameter was used to measure air flows in the range of 25-500 muminute. Air Measurements were made using colorimetric air monitoring tubes for Nitrogen Dioxide and Nitrogen Oxides provided by Kitagawa Corp. About 15 mL the reagent composition of the present invention was placed in a glass micro-impinger consisting of a 20 mL glass bottle fitted with a glass capillary in close proximilty to and directed toward the bottom of the bottle. When the glass capillary is pressurized, Input Air passes through the capillary and “impinges” on the solution as micro-bubbles directed at the bottom of the bottle. After entering the impinger, air bubbles rise to the top of the liquid, then make their way out of the exhaust port to become Output Air. Input Air containing NO₂ was directed first into a Kitagawa measuring tube and then into a Gas Rotameter. The Flow Rate was recorded and the color displacement zone of the measurement tube was observed as a function of time to determine the NO₂ concentration of Input Air. The same Input Air containing NO₂ was then directed first into the Lab Impinger containing the reagent composition, then into a Kitagawa measuring tube, and then into a Rotameter. The Flow Rate was recorded and the color displacement zone of the measurement tube was observed as a function of Time to determine the NO₂ Concentration of Output Air relative to Input Air. The same Input Air containing NO₂ was directed first into a Lab Impinger containing only pure water, then to a measuring tube, and then to a Rotameter. The Flow Rate was recorded and the color displacement zone of the measurement tube was observed as a function of Time to determine the NO₂ Concentration of Output Air. The NO₂ concentration of Output Air was compared to the NO2 concentration of Input Air to determine the Capture Ratio for NO₂. The results are shown in Table 4 below.

TABLE 4

| | | | NO₂ | CAPTURE |
|---|---|---|---|---|
| SAMPLE | TUBE | FLOW | (ppm found) | RATIO |
| Input Air | NO₂ | 100 ml/min | 19.1 | 24% |
| Output Air | NO₂ | 100 ml/min | 14.6 | |
| Input Air | Nitrogen Oxides | 100 ml/min | 18.9 | 25% |
| Output Air | Nitrogen Oxides | 100 ml/min | 14.3 | |
| Input Air | NO₂ | 50 ml/min | 10.5 | 31% |
| Output Air | NO₂ | 50 ml/min | 7.2 | |
| Input Air | Nitrogen Oxides | 50 ml/min | 10.8 | 33% |
| Output Air | Nitrogen Oxides | 50 ml/min | 7.2 | |

It is noted that results with pure water in the impinger were no different from “Input Air” results. The above data show that when Input Air containing 5-20 ppm NO₂ is directed to an scrubber containing the reagent composition of the present invention, a portion of the NO₂ is be captured by the solution. The Capture Ratio was found to be 25-36% in these experiment, and the extent of capture is expected to be dependent upon the Flow Rate, Solution Volume, and other factors.

In order to demonstrate whether changing certain experimental parameters could increase the Capture Ratio for NO₂, it was decided to employ lower levels of Nitrogen Dioxide (closer to the exposure limit regulations) and to employ a second liquid Impinger in order to double the amount of the reagent composition contacting the gas stream. Lower levels of NO₂ gas utilized in flow system, 4-10 ppm NO₂. A Second Impinger containing the reagent composition of the present invention was placed in series with the first Impinger. The results are shown in Table 5 below.

TABLE 5

| | | | NO2 | |
|---|---|---|---|---|
| | | | (ppm | CAPTURE |
| SAMPLE | TUBE | FLOW | found) | RATIO |
| Input Air | NO₂ | Reference | 3.8 | |
| Output Air | NO₂ | Single Impinger | 3.0 | 22% |
| Output Air | NO₂ | Double Impinger | 1.0 | 75% |
| Input Air | NO₂ | Reference | 3.9 | |
| Output Air | NO₂ | Single Impinger | 2.8 | 27% |
| Output Air | NO₂ | Double Impinger | 1.2 | 69% |
| Input Air | Nitrogen Oxides | Reference | 8.2 | |
| Output Air | Nitrogen Oxides | Single Impinger | 5.1 | 37% |
| Output Air | Nitrogen Oxides | Double Impinger | 2.1 | 74% |
| Input Air | Nitrogen Oxides | Reference | 8.1 | |
| Output Air | Nitrogen Oxides | Single Impinger | 5.5 | 32% |
| Output Air | Nitrogen Oxides | Double Impinger | 2.7 | 67% |

The data show that the Capture Ratio was found to be 22-37% in this experiment (similar to first experiment) when a single Impinger was used. Further, capture ratio increased dramatically (to 67-75%) when a second Impinger was added. Additional liquid contact is required to obtain high Capture Ratios for NO₂.

### EXAMPLE 7

This example demonstrates the effects of the reagent composition of the present invention Example 3 for removing VOCs from a gas stream. In using this reagent to cleanse air for ventilation, one objective was to bubble air through the solution in such as way that air pollutants are trapped in solution leaving purified air as the output. To challenge the solution of the present invention in such a way that any liquid with a tendency to vaporize can be separated from the reagent composition and analyzed.

About 200 mL the reagent composition of the present invention was placed in a glass bottle with a PTFE-lined cap. A Diffusive Sampler (AT541) containing charcoal was opened and attached to the inside the bottle cap so, it would remain above the liquid surface (facing down) when the cap was replaced. The bottle cap was screwed onto the bottle and Diffusive Sampling of the “head space” (the air space above the liquid) was conducted for 72 hours. A duplicate set-up was prepared to provide a second sample for analysis. Two (2) additional samples were prepared as “controls” with 200 mL pure water in place of the reagent composition.

Four (4) samples identical to the above set (i.e., two (2) samples with 200 mL of the reagent composition and two (2) pure water “controls”) were prepared, so that a second identical test could be conducted at a higher temperature [37° C. (100° F.)] for 72 hours of sampling.

After 72 hours, all eight Samples were removed for Gas Chromatography analysis. After 72 hours of sampling, the eight (8) Diffusive Samplers were removed from the bottle caps and their charcoal discs were analyzed by gas chromatography to determine the presence of any volatile solvents. Half the charcoal discs (representing each of the four test conditions: room temperature, 370 C, and their corresponding pure water controls) were extracted with 100% Carbon Disulfide, and each extract analyzed by GC for Total Non-Polar Solvents using dual, simultaneous capillary columns (60 M×0.32mm) coated, respectively, with 1% Methyl Silicone (Restek “RT-1”) and 1% Phenyl Methyl Silicone (Restek “RT-Volatiles” columns) using a temperature program from 30° C. to 200° C. All chromatography peaks emerging during the run (after the Carbon Disulfide peak) were integrated, added together, and converted to micrograms of carbon relative to a hexane standard. The pure water control was treated similarly and the value obtained was subtracted from the value for the reagent composition sample.

The other half of the charcoal discs (representing the same four test conditions) were anaylzed by a second method designed to detect specific polar solvents and dipropylene glycol. The four charcoal discs were extracted with 97% Carbon Disulfide +3% Benzyl Alcohol and analyzed specifically for 25 common solvents and dipropylene glycol with an estimated Detection Limit of 1.0 micrograms of each solvent per sample. Each extract was analyzed by GC for Total Non-Polar Solvents using dual, simultaneous capillary columns (60 M×0.32mm) coated, respectively, with 1% Methyl Silicone (Restek “RT-1”) and 1% Phenyl Methyl Silicone (Restek “RT-Volatiles” columns) using temperature a program from 30° C. to 200° C. Chromatography peaks emerging during the run were compared to the specific peak areas and retention times determined for each of the 26 chemicals on each of the two chromatography columns. The pure water control was treated similarly and the values obtained for each chromatography peak were subtracted from the value for the reagent composition sample.

Less than 40 micrograms (i.e. no detectable amounts) of organic solvents were detected in any of the four samples. (Reagent Composition at Room Temperature, Reagent Composition at 37° C., and the respective pure water controls). In addition, less than 1.0 micrograms (i.e., no detectable amounts) of any of the solvents were detected in any of the four samples. (Reagent Composition at Room Temperature, Reagent Composition at 37° C., and the respective pure water controls)

The data shows that when the reagent composition of the present invention was enclosed in a sealed bottle and allowed to come to equilibrium with a charcoal sampler for 72 hours, no detectable amounts of non-polar organic solvents, polar organic solvents, or dipropylene glycol were detected in the air space above the reagent composition. In addition, when the reagent composition of the present invention was enclosed in a sealed bottle heated at 37° C. (99° F.) and allowed to come to equilibrium with a charcoal sampler for 72 hours, no detectable amounts of non-polar organic solvents, polar organic solvents , or dipropylene glycol were detected in the air space above the reagent composition. Further, dipropylene glycol is not significantly vaporized from the reagent composition of the present invention at temperatures as high at 99° F. Also, no volatile organic solvents were detected as vaporized from the reagent composition of the present invention at temperatures as high at 99° F. Finally, the reagent composition of the present invention contains minimal amounts of volatile organic solvents.

The above description is for the purpose of teaching a skilled artisan how to practice the invention, and it is not intended to detail all of those obvious modifications and variations of it which will become apparent to the skilled worker upon reading the description. It is intended, however, that all such obvious modifications and variations be included within the scope of the invention which is defined by the following claims. The claims are meant to cover the claimed elements and steps in any arrangement or sequence that is effective to meet the objectives there intended, unless the context specifically indicates the contrary. Those skilled in the art will recognize, or be able to ascertain using no more than routine experimentation, many equivalents to the specific embodiments of the invention specifically described herein. Such equivalents are intended to be encompassed in the scope of the invention.

What is claimed is:

1. A composition for removing a contaminant from a gas comprising: (1) a silicate compound and (2) a sequestrant.

2. The composition of claim 1, wherein the silicate compound is selected from at least one member of the group consisting of: sodium orthosilicate, sodium sesquisilicate, sodium sesquisilicate pentahydrate, sodium metasilicate (anhydrous), sodium metasilicate pentahydrate, sodium metasilicate hexahydrate, sodium metasilicate octahydrate, sodium metasilicate nanohydrate, sodium disilicate, sodium trisilicate, sodium tetrasilicate, potassium metasilicate, potassium metasilicate hemihydrate, potassium silicate monohydrate, potassium disilicate, potassium disilicate monohydrate, potassium tetrasilicate, potassium, and tetrasilicate monohydrate.

3. The composition of claim 2, wherein the silicate compound is sodium metasilicate.

4. The composition of claim 1, wherein the sequestrant is selected from at least one member of the group consisting of: sodium gluconate, sodium citrate, sodium p-ethylbenzenesulfonate, sodium xylenesulfonate, citric acid, and EDTA.

5. The composition of claim 4, wherein the sequestrant is sodium gluconate.

6. The composition of claim 1, further comprising at least one compound selected from the group consisting of butyl diglycol, dipropylene glycol and EDTA.

7. The composition of claim 1, further comprising a surfactant.

8. A composition for removing a contaminant from a gas comprising sodium metasilicate, sodium gluconate and butyl-diglycol.

9. A composition for removing a contaminant from a gas comprising EDTA, sodium metasilicate, and butyl-diglycol.

10. The composition of claim 9, further comprising a surfactant.

11. A composition for removing a contaminant from a gas comprising dipropylene glycol, and sodium metasilicate.

12. The composition of claim 11, further comprising a surfactant.

13. A method for separating a contaminant from a stream of contaminated air, comprising:
(a) passing said contaminated air into a contact zone in which is disposed a composition of any one of claims 1 to 12;
(b) withdrawing from said contact zone air depleted of said contaminant.

14. The method of claim 13, wherein the contaminant is selected from at least one member of the group consisting of COₓ, SOₓ, NOₓ, H₂S, IHAP, benzene, formaldehyde, acetone, toluene, methylene chloride and mercury.
